(19) United States
(12) Patent Application Publication
(10) Pub. No.: US 2017/0278178 A1
(43) Pub. Date: Sep. 28, 2017

(54) METHODS FOR OFFERING PRODUCTS FOR SALE ONLINE USING PREPOPULATED PRODUCT IMAGES AND DESCRIPTIONS

(71) Applicant: Chi Huynh, San Dimas, CA (US)

(72) Inventor: Chi Huynh, San Dimas, CA (US)

(21) Appl. No.: 15/472,253

(22) Filed: Mar. 28, 2017

Related U.S. Application Data
(60) Provisional application No. 62/314,357, filed on Mar. 28, 2016.

(51) Int. Cl. G06Q 30/06; G06Q 10/08

(52) U.S. Cl. CPC G06Q 30/0641; G06Q 10/087; G06Q 30/0633

(57) ABSTRACT

A method for offering products or services for sale online, which includes hosted accounts for wholesalers that offer goods or services to retailers at wholesale pricing, and hosted accounts for retailers that offer goods or services to consumers at retail pricing, wherein the wholesaler account includes attributes describing the goods or services; transferring a request between a retailer and a wholesaler to add goods or services from the wholesaler's hosted account for sale on the retailer's hosted account; and if accepted populating the retailer's hosted account with goods or services and the attributes from the wholesaler's hosted account, thereby permitting the retailer to sell the populated goods or services to consumers without generating new product or service descriptions.

### CROSS REFERENCE TO RELATED APPLICATIONS

This application claims benefit of priority to U.S. provisional patent application No. US 62/314,357, filed Mar. 28, 2016, the content of which is herein incorporated by reference in its entirety.

### TECHNICAL FIELD

The invention relates to methods for selling goods and services online and more specifically to methods of offering goods for sale through a plurality of retailer's online stores and methods of distributing payment from online purchases.

### BACKGROUND OF THE INVENTION

The need for retailers to carry inventory for e-commerce stores often creates a barrier for entry. To this end, a supply management method has been developed, termed “drop shipping” where a retailer does not keep goods in stock but instead transfers customer orders and shipment details to either the manufacturer, another retailer or a wholesaler, who then ships the goods directly to the consumer.

While drop-shipment has decreased the barrier for entry on retailers, it has increased the shipping and distribution burden on wholesalers and manufacturers, which conventionally shipped in bulk at lower transaction costs. With the increased availability and pressure to establish drop shipment service, manufacturers and wholesalers are increasingly required to improve distribution channels without the added profit obtained through retail distribution.

Accordingly, there is a need to provide improved methods for offering products online that reduce the barriers of entry for retailers but permit wholesaler's to recoup increased costs associated with drop shipping methods.

### SUMMARY OF THE INVENTION

The invention provides methods for offering products online that reduce the barriers of entry for retailers and permit wholesaler's to recoup increased costs associated with drop shipping methods.

In one aspect of the invention, a method for offering products or services for sale online is provided, which includes: providing a central authority having hosted accounts for wholesalers that offer goods or services to retailers at wholesale pricing, and hosted accounts for retailers that offer goods or services to consumers at retail pricing, wherein the wholesaler account includes attributes describing the goods or services; transferring a request between a retailer and a wholesaler through the central authority, wherein the request is an offer to add goods or services from the wholesaler's hosted account for sale on the retailer's hosted account; transferring an acceptance or denial of the request between the retailer and the wholesaler through the central authority; and if accepted populating the retailer's hosted account with goods or services and the attributes from the wholesaler's hosted account, thereby permitting the retailer to sell the populated goods or services to consumers without requiring additional product or service descriptions by the retailer. The wholesaler can be a conventional distributor that distributes to retailers or manufacturers.

In some embodiments, the request is sent by a retailer to a wholesaler. In other embodiments the request is sent by a wholesaler to a retailer. Preferably, the hosted accounts are hosted by a shared host to facilitate communication between wholesalers and retailers and to population the goods, services and attributes directly to the retailer's account preferably embodied as an online e-commerce store.

In some embodiments, the wholesaler's goods or services are privately viewed by select retailers. In other embodiments, the wholesaler's goods/services are open for viewing by all retailers within the shared host. Selection can be according to invitation such as through the request. In some embodiments the request is sent through a messaging or email application through a shared host that hosts the hosted accounts.

In some embodiments, the attributes are selected from one or more of the group consisting of a picture, a description, a specification, a product or service review, a quality rating, and others. Preferably, the retailer's hosted account is populated with the one or more accepted collections. In some embodiments, collections are provided as a single page with wholesaler promotional information.

Once populated, the one or more collections are grouped and searchable on the retailer's site, such as by brand, wholesaler, product, and others. The online store may be programmed with tabs representing brands, collections, or others, which sort the available products. The online store can have wholesaler page, which closely resembles the wholesaler's page.

In some embodiments, the online store mirrors the wholesaler's product pages. In some embodiments, each of the wholesalers' selected product pages are mirrored across a plurality of the retailer's pages, which are selectable by the consumer. Thus, a wholesaler can control the appearance of the wholesaler's goods services to ensure consistency of product branding.

In some embodiments, the product or service attributes can be edited by the wholesaler after migration or population. In some embodiments, the product or service attributes can be edited by the retailer on the retailer's hosted account. In some embodiments, the wholesaler is notified upon edits by the retailer.

Since the retailers are preferably provided as e-commerce sites, the retailer's hosted accounts can include shopping cart programming on the retailer's web site for purchase of the goods/services.

In a related aspect, a method of migrating products or services from one website to another is provided, which includes providing a host that hosts accounts for wholesalers that provide one or more collections of goods or services available to retailers for retail sale and accounts for a retailers that offer goods or services to consumers, wherein wholesaler uploads one or more attributes for the goods or services; and duplicating the attributes to a website hosted by the retailer. In some embodiments the retailer's site is updated with new offerings by the wholesaler, optionally by first requesting an update permission.

In another related aspect, the invention provides systems for offering products manufactured or wholesaled by another online, which includes a hosted account for a wholesaler or manufacture to provide a collection of goods available for retailers, wherein the hosted account provides attributes attributed to goods/services available for migration; a hosted account for a retailer that offer's products to consumers; and a means for transferring the attributes to the retailer(s)'s site(s).

In another related aspect the invention provides a computer system having a plurality of hosted accounts by wholesalers and retailers that permits the invitation, acceptance and sale of wholesaler's products on the retailers' websites, wherein the product descriptions are generated primarily by the wholesalers.

### BRIEF SUMMARY OF THE DRAWINGS

FIG. 1 is a diagram providing an overview of an exemplary architecture of a central authority 110 that provides an interactive portal between a plurality of wholesalers 120 and a plurality of retailers 130, thereby permitting the importation of product lines into a retail e-commerce website for consumer 140 access over the internet.

FIG. 2 is a flow chart demonstrating an overview of the methods providing online store formation 205, communication between retailer and wholesaler 210a, 210b, 215a, 215b, population of an online store 220, product reviews 225, product review code display 230, retail sale of goods 235, drop shipment by a wholesaler 240, and payment to a retailer 245 and product reviewer 250.

FIG. 3 is an example of a graphic user interface available to a retailer, which shows a wholesaler's account (GALATEA) with product collections 310 available for populating into a retailer's online store for offering the products to consumers and associated promotional videos 320.

FIG. 4 is an example of a graphic user interface available to a consumer after populating a retailer's online store (PAV & BROOME) with populated product collections 410 from the wholesaler web page of FIG. 3. As can be seen, in addition to goods/services, further information regarding the wholesaler, such as populated promotional videos 420 are also provided.

FIG. 5 is an example of a graphic user interface of a retailer's account showing an invitation 510 from a wholesaler to join as a retailer for the wholesaler's products/services together with other suggested wholesalers 520 displayed based on similarity to other wholesalers already offered by retailer or by criteria previously inputted by retailer.

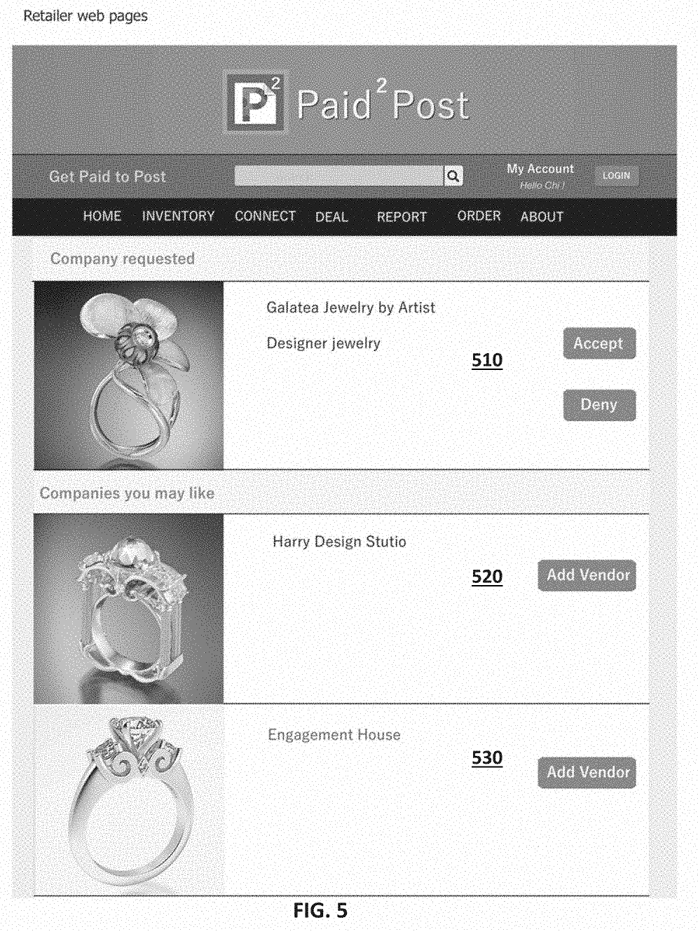

FIG. 6 is an example of a graphical user interface for consumers showing a listing of available brands 610, 620, 630 offered by the retailer.

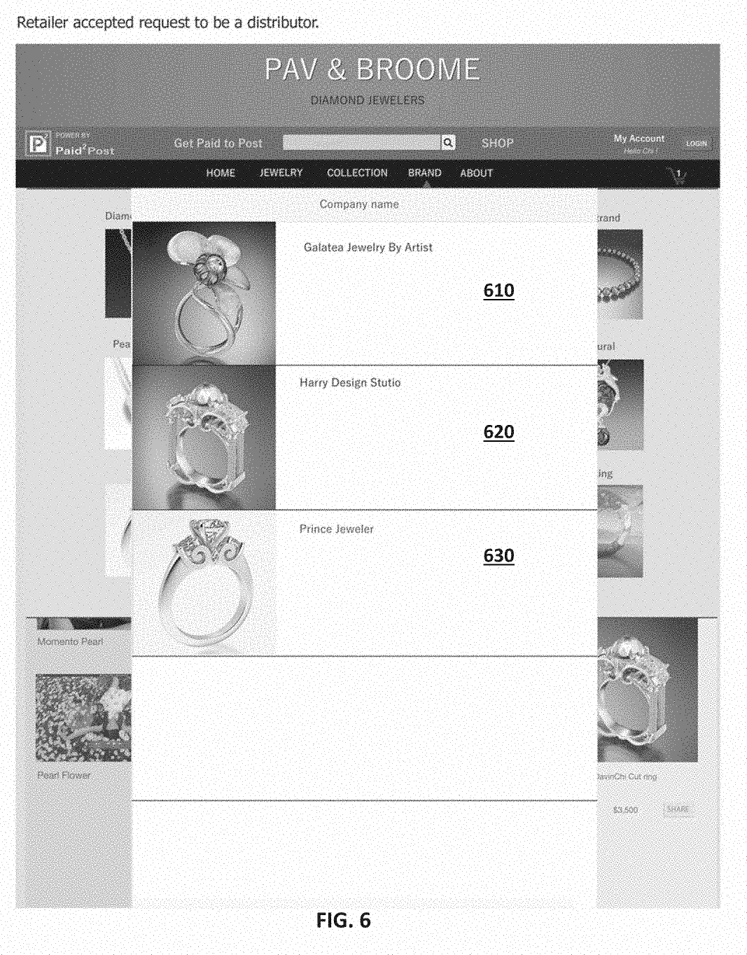

FIG. 7 is an example of a graphical user interface showing product collections 710, 720, 730, 740 offered by a retailer, which can be wholesaler specific or can be a listing of collections from all wholesalers.

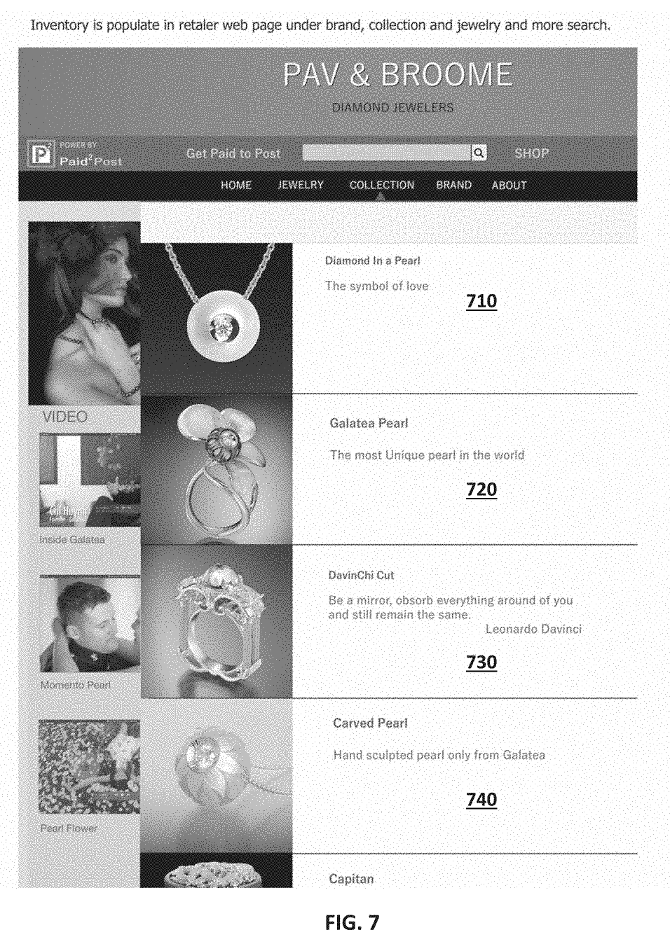

### DESCRIPTION OF PREFERRED EMBODIMENTS

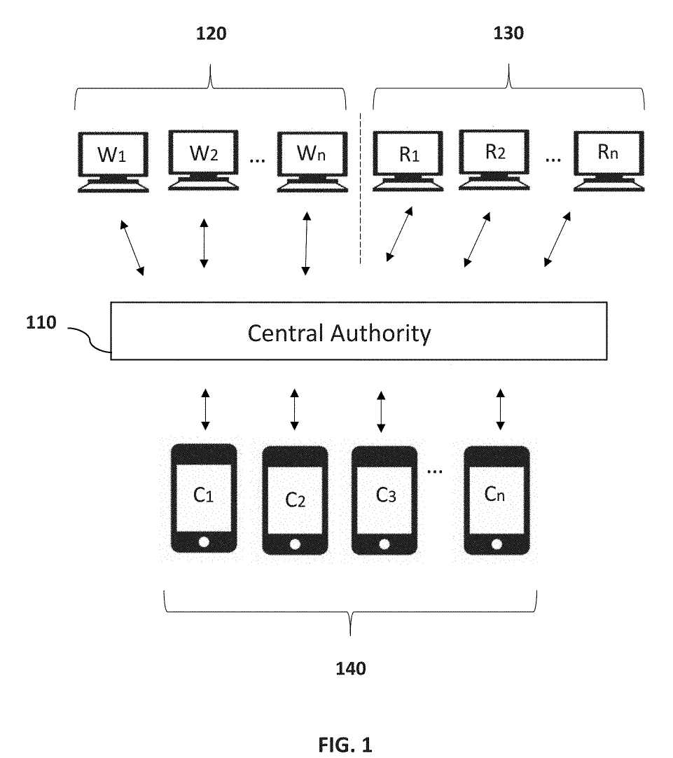

Referring to FIG. 1, the invention provides methods for offering products or services for sale online, which includes an central authority 110 having hosted accounts for wholesalers 120 that offer goods or services to retailers 130 at wholesale pricing, and hosted accounts for retailers 130 that offer goods or services to consumers 140 at retail pricing.

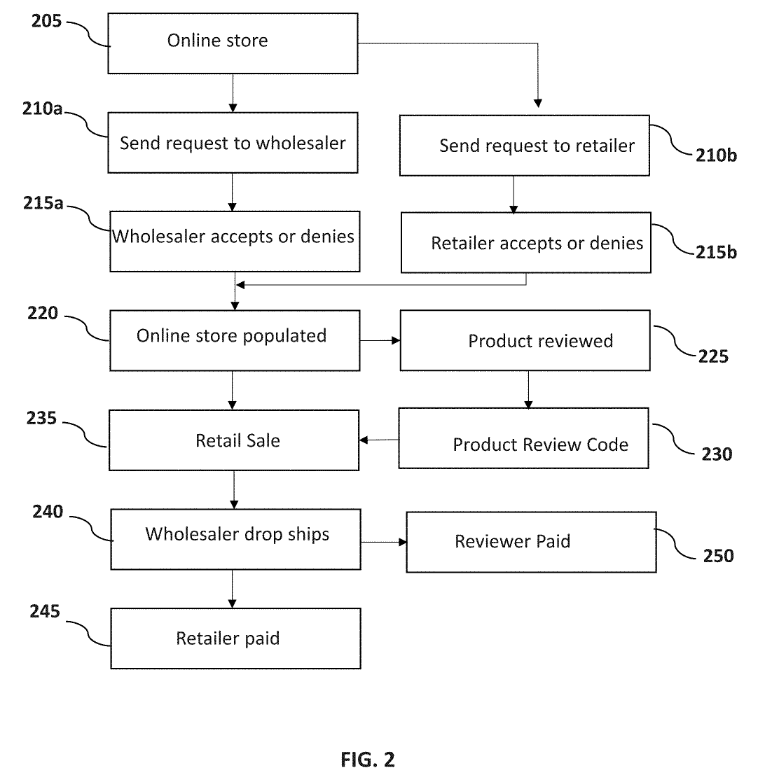

Turning to FIG. 2, the method includes generating an online store 205, transferring a request between a retailer and a wholesaler 210a, 210b through the central authority, wherein the request is an offer to add goods or services from the wholesaler's hosted account for sale on the retailer's hosted account; and transferring an acceptance or denial of the request between the retailer and wholesaler 215a, 215b through the central authority. If an acceptance is transferred, the method further comprises populating the retailer's hosted account 220 with one or more goods or services from the wholesaler's hosted account, thereby permitting the retailer to sell the goods or services 234 populated on the retailer's account to consumers. After which the wholesaler ships the goods 240 and the seller is paid 245. In instances where a product reviewer reviews a product 225, a product review code can be supplied 230 and the review paid a commission 230 after shipment 240.

Returning to FIG. 1, the central authority 110 is itself a computer-based system, such as a computer server, accessible over the Internet, loaded with software capable of establishing individual accounts and regulating the communication between the individual accounts. In particular, the central authority 110 differentiates between wholesaler accounts 120 and retailer accounts 130 by account specific identifiers, which together with attributes assigned to products, improves the efficiency of online retail stores and their offering of inventory from a plurality of wholesalers 120 for retail purchase by consumers 140 through retailers 130. Further, by differentiating between wholesaler accounts 120 and retailer accounts 130, the central authority 110 efficiently matches wholesalers 120 to retailers 130 and populates goods and services consistent with the retail store into the online store itself, and efficiently populates online stores with additional supporting files associated with particular goods and services. The central authority 110 also provides the efficient distribution of funds from product sales and increases the efficiency drop shipment methods.

Wholesalers 120 and retailers 130 are initially registered or added to the system and methods by contacting the central authority, which is typically performed by visiting a published website hosted by the central authority. Once enrolled, the user login and password information is provided as known in the art to which the invention belongs. During registration, the user indicates whether a wholesaler 120, a retailer account 130 or both is to be established, thereby designating the general architecture of the site.

The systems and methods provide website templates or website themes for displaying products and services, which may differ depending on whether the user is a wholesaler 120, a retailer 130 or both. For example, a retailer 130 may choose a more ornate or interactive theme to entice consumers, while a wholesaler 120 may prefer a more streamlined basic listing of available products for importation into the retailer's theme. Wholesaler 120 that is also a retailer 130 may choose a theme for consumers 140 and a simpler listing for retailers 130. To this end, the wholesaler and retailer accounts 120, 130 are hosted and displayed by the central authority 110.

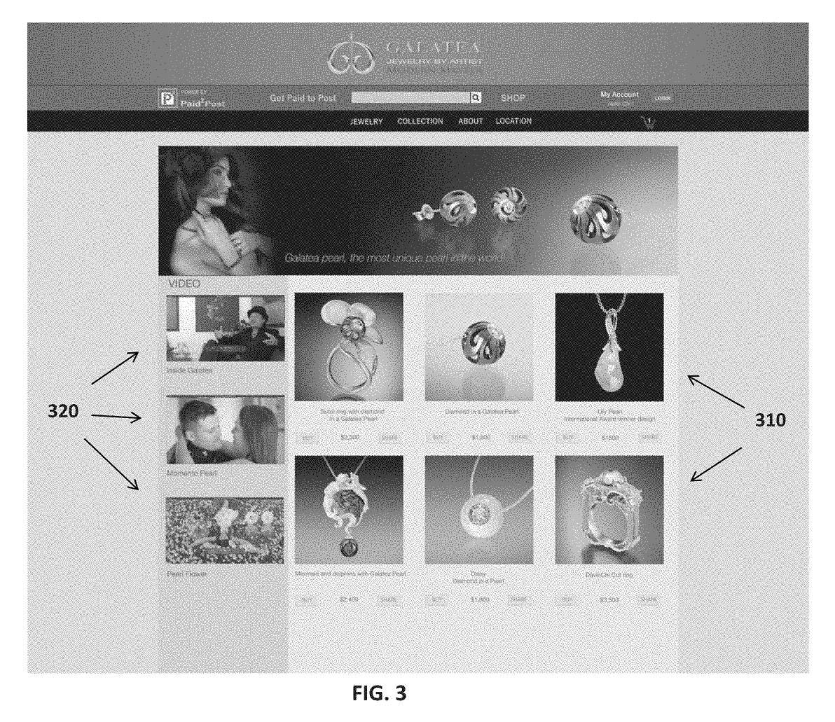

As shown more clearly in FIG. 3, During set up of a wholesaler account, the wholesaler uploads photos and descriptions of the goods or services (referred to as “attributes”) available for wholesale. Photos and descriptions can be further grouped into product or service categories or collections 310. As such, the wholesaler is primarily tasked with generating product descriptions for the retailer and classifying the product category for inclusion into the retailer's online store. As an example, a wholesaler's collection 310 of jewelry may be categorized by “jewelry” then “rings” or “necklaces.” A wholesaler's collection 310 of toys may be grouped by “toys” then “games” or “dolls.” By the wholesaler's selective grouping of products, the central authority can import both the products and their menu hierarchy to improve arrangement within the retailer's online store by merely selecting an “add” feature by the retailer. In some embodiments, there is an edit function where the wholesaler may edit the photos and product descriptions prior to population on the retailer's online store.

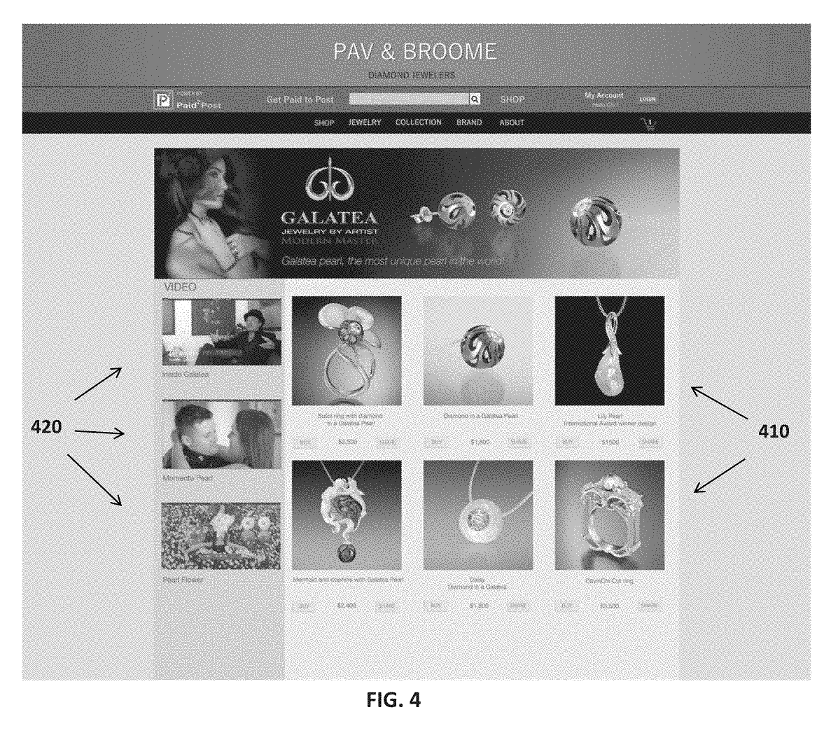

By defining goods/service collections 310, the wholesaler can not only display the individual members of the collection but can also upload additional files advertising the collection, such as promotional videos 320 or instructions. As shown in FIGS. 3 and 4, these additional files, such as promotional videos 320 can be populated directly into the retailer's online store as populated advertising videos 420. Accordingly, the methods permit the population of products and services as well as promotional materials supplied by the wholesaler without significant effort or expertise by the retailer. Still further, the wholesaler's account can includes an update feature, which permits files to be updated at the retailer's account without requiring any coding by the retailer. Updating typically involves a notification to the retailer requesting an update and occurs automatically in response to its acceptance.

In some embodiments, the wholesaler also sets a retail price or a minimum retail price that the goods or services can be sold by the retailer.

Turning back to FIG. 2, retailers are assigned a retail account in the form of an online store 205; however, the retailer account includes an importation feature which permits importing products or services offered by wholesalers. A retail account permits the retailer to populate the online store with products directly from available wholesaler accounts. As such, the retailer account is adapted to import images, product descriptions and promotional material from a variety of wholesalers.

The architecture of the retailer account is primarily regulated by the central authority template. In preferred embodiments, the retailer is provided with a website builder incorporating preconfigured standard templates and customizable templates for creating banner fields, image or video fields, and text fields as desired by the owner. While the website builder allows the retailer to design the overall appearance of the online store 205, the product or service images and descriptions are preferably directly imported from the predefined images and descriptions provided by the wholesaler. In some embodiments the retailer is able to use a drag and drop approach to reorder the products on a web page. In some embodiments, though not preferred, the retailer is provided with an editor, which permits editing the wholesaler images and text.

In some embodiments the retailer's hosted account is integrated into a website that is not hosted by the central authority. In such instances, the retailer's shopping cart interfaces with the retailer's hosted account to maintain the availability of the item in the shopping cart and to execute payment to the wholesaler and any third party advertisers.

The systems and methods match wholesalers and retailers for connection using different approaches. One approach is an invitation or request approach, where either the wholesaler or retailer can send a request to the other 210a, 210b. This can be done by searching available retailers or wholesalers in an account search feature. In such embodiments, the wholesaler would accept or deny a request from a retailer 215a; or a retailer would request or deny a request from a wholesaler 215b.

In some embodiments, a request is conditionally accepted such that additional requirements are placed on the acceptance. Such conditions may include sales goals or website traffic requirements. In instances of conditional acceptance, the acceptance and requirements can be monitored by the central authority and if the requirements are not met, the product access automatically revoked. In further embodiments, the central authority generates warning notifications prior to revocation.

Sending 210a, 210b and accepting 215a, 215b a request, can include an authorization to import an entire collection from the wholesaler's available goods or only a portion of the available goods. A retailer may wish to limit the importation of goods so that the retailer can be a specialty store; and a retailer may wish to limit the importation of goods so that the wholesaler can provide exclusive offerings to different retailers, such as those that are higher volume retailers, specialty retailers, or those in different geographical regions or countries.

In another approach retailers and wholesalers are matched according to similarity of industry, where similar industries are notified in a suggested pairing. As an example, the central authority may suggest the matching of a jewelry manufacturer with a jewelry retailer. The wholesaler (in this case manufacturer) or retailer can then initiate a request for pairing, which then requires an acceptance.

In another approach, retailers and wholesalers are matched by comparing a listing of retailers already connected with the wholesaler and a listing of wholesalers already connected to the retailer, where overlapping connections initiates a suggested pairing of wholesaler to retailer. The wholesaler or retailer can then initiate a request for pairing, which then requires an acceptance

Once a request is accepted, the goods or services offered by the wholesaler can be populated into the retailer's online store 220. In some instances, the all goods available from the wholesaler are imported. In other embodiments, fewer than all goods available from the wholesaler are imported.

Selecting only a portion of available goods can be performed by visiting the wholesaler's hosted page and selecting which items to import, such as by check boxes selectively available to retailers. The wholesaler may have an “accept all” feature where no further authorization is required or may require further authorization prior to importation. By categorizing products and services, the wholesaler also provides the option for the retailer to import certain categories or product lines offered by the wholesaler.

Preferably, once the selected goods/services are imported to the retailer's online store 220, the wholesaler may offer additional goods/services using a notification message, which may permit the retailer to view new offerings and accept or deny their importation into the online store. Preferably, once connected the wholesaler or retailer may cancel at any time.

Retail sales to consumers 235 are conducted by retailers. Preferably, items ordered through online retailers are drop-shipped from the wholesaler 240. This permits the retailer to avoid maintaining high volumes of merchandise and avoids shipping costs between wholesaler and retailer, which ultimately is passed on to consumers. Using the drop shipment approach, fees due to the wholesaler can be sent from the retailer.

In a preferred approach, the central authority receives the consumer's payment, credits the wholesaler's account and credits retailer's account 245 with the assigned amount from the sale, which can be a percentage or flat amount.

The systems and methods also permit the wholesaler to maintain a retail store. Preferably, in such embodiments, the retail sale of goods or services also require retailers be paid a commission by the wholesaler. In such an approach, retailers receive maximum commission on all sales made from their own online store but a lesser commission from a wholesaler's retail store. For retail purchases made from wholesaler's portal or online store, personalized consumer links, or from direct hosted search, a participating retailer is automatically assigned as a servicer and receives a percentage of the sale. In such embodiments, a participating retailer would be assigned by closest zip code to purchaser or “ship to” address. Under this approach, wholesalers are not siphoning profits from retailers, rather they are “eating at the same table”, and it is now in their mutual interests to generate sales.

The systems and methods provide a further embodiment by allowing any registered consumer or registered unauthorized dealer to post merchandise on social media, such as in a product review 225 or in a social media environment and receive a commission 250 of his or her own. In such embodiments, the consumer would likely be a registered user of the systems and methods and thus the postings can be monitored by the central authority. In some embodiments the registered user is a registered product reviewer. In other embodiments, the registered user is consumer that previously purchased the product or service. In this case the wholesaler, the retailer, and the consumer all benefit from the sale.

Registered product reviewers can themselves generate hosted accounts displaying their product reviews or may be assigned a reviewer code. Upon ordering, adding the reviewer code 230 in an appropriate ordering field during checkout would credit the registered product reviewer's account. As an example, a registered product reviewer can receive a special posting code that allows them to collect a 5-10% commission from any sale their post generates. In essence, everyone is a paid representative and advocate.

In another approach, consumers or third party advertisers themselves are able to post reviews or comments regarding a particular good or service and be eligible to receive a commission using a posting code. To this end, individual posts will spread the brand far and wide with zero upfront cost.

When using product reviewers, third party advertisers or consumers, the systems and methods can be monetized by a small percentage of each sale, which after the transaction has been made and shipped. The central authority collects all sales and distributes funds to all appropriate parties after the item is shipped. Furthermore, the system manages all returns and repayments.

Both retailers and wholesalers can link directly from their websites to the system's fully functional personalized page portal created just for them.

Through advertising and promotions, the system seeks to attract customers directly to the site and build an independent brand. Thus, it will also be able to leverage the reputation and promotional activities of participating retailers and wholesalers to attract customers to the service site.

Consumers will benefit in meaningful and substantial ways via 24/7 access to the e-store; branded products and broad merchandise selection; certainty of quality, integrity and value; and superior customer service interactions with Paid2Post via the Internet or “in person” at Paid2Post-affiliated retail stores.

What is claimed is:

1. A method for offering products or services for sale online, comprising:
providing a central authority comprising hosted accounts for wholesalers that offer goods or services to retailers at wholesale pricing, and hosted accounts for retailers that offer goods or services to consumers at retail pricing, wherein the wholesaler account includes attributes describing the goods or services;
transferring a request between a retailer and a wholesaler through the central authority, wherein the request is an offer to add goods or services from the wholesaler's hosted account for sale on the retailer's hosted account;
transferring an acceptance or denial of the request between the retailer and the wholesaler through the central authority; and if accepted
populating the retailer's hosted account with goods or services and the attributes from the wholesaler's hosted account, thereby permitting the retailer to sell the populated goods or services to consumers without requiring additional product or service descriptions.

2. The method according to claim 1, wherein the central authority receives payments from consumers and credits accounts of the wholesaler and retailer after sale.

3. The method according to claim 1, wherein the wholesaler is a manufacturer of the goods.

4. The method according to claim 1, wherein the request is sent by the retailer to the wholesaler.

5. The method according to claim 1, wherein the request is sent by the wholesaler to the retailer.

6. The method according to claim 1, wherein the wholesaler's goods or services are privately viewable by select retailers.

7. The method according to any claim 1, wherein the request is sent through a messaging or email application through the central authority.

8. The method according to claim 1, wherein the attributes are selected from one or more of the group consisting of a picture, a description, a specification, a product or service review, and a quality rating.

9. The method according to claim 1, wherein the goods or services are searchable on the retailer's account by one or more selected from the group consisting of a brand, a wholesaler, and a product name.

10. The method according to claim 1, further comprising shopping cart programming on the retailer's web site for purchase of the goods, services.

11. The method according to claim 1, wherein the retailer's site is updated with new offerings by the wholesaler, optionally by first requesting an update permission.
